(19) United States
(12) Patent Application Publication
(10) Pub. No.: US 2010/0327759 A1
(43) Pub. Date: Dec. 30, 2010

(54) ELECTRONIC BALLAST FOR A FLUORESCENT LAMP

(75) Inventors: Hendrik Jan ZWERVER, Eindhoven (NL); Hendrik Jan BLANKERS, Oss (NL); Deepak Shivaram SHET, Hoffman Estates, IL (US); Lucas VOS, Hanover Park, IL (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/725,526

(22) Filed: Mar. 17, 2010

(30) Foreign Application Priority Data
Jun. 24, 2009 (EP) 09163635.7

(51) Int. Cl. H05B 41/36

(52) U.S. Cl. 315/210; 315/224

(57) ABSTRACT

An electronic ballast for supplying a lamp load is described. The electronic ballast comprises an inverter arranged in a half-bridge configuration for providing an AC voltage and at least one lamp load circuit. The inverter comprises an upper switch, connected to a DC terminal for receiving a DC supply voltage, and a first lower switch arranged in a half-bridge configuration for generating an AC voltage at an inverter terminal of the inverter. A first diode and a second lower switch are connected in series. This series arrangement is connected in parallel with the first lower switch. A lamp load circuit for supplying the lamp load is connected to a node between the first diode and the second lower switch. When the inverter supplies a fluorescent lamp, and the lamp load circuit comprises a heating circuit for heating an electrode of the fluorescent lamp, the heating circuit includes a heating transformer and a second lower switch connected in parallel with the primary winding of the transformer. By doing so, the heating circuit can be operated and controlled independent of the current supplied to the fluorescent lamp, or operating conditions of the fluorescent lamp.

### FIELD OF THE INVENTION

The invention relates to the field of lighting systems, in particular to fluorescent lamps. Prior to the ignition of such a fluorescent lamp, the electrodes of such a lamp are (pre) heated. The present invention provides an electronic ballast for operating one or more fluorescent lamps and other lamp load circuits such as a heating circuit.

### BACKGROUND OF THE INVENTION

Electronic ballasts for fluorescent lamps including a heating circuit for heating the electrodes of the fluorescent lamps are e.g. described in US 2007/0296355 or U.S. Pat. No. 5,854,538. In order to heat or pre-heat the electrodes of a fluorescent lamp, a series connection of a capacitor, a primary winding of a heating transformer and a switch or switching element can be applied. The heating transformer can e.g. be provided with secondary windings arranged to provide a heating current to the electrodes.

A drawback of such an arrangement is that the heating can never be fully turned off if the heating switch is in off state. This is due to the fact that all types of switches have a parasitic capacitor and this causes a leakage current to flow through the primary side of the heating transformer, thus causing also a heating current through the electrodes. This (leakage) heating current is not necessary at 100% lamp discharge current. It however does contribute to a lower fluorescent driver energy efficiency and is therefore undesired.

In general, the electronic ballast comprises an half bridge, HB, inverter for providing an AC power to the fluorescent lamp. In order to determine the power provided to the lamp, such an inverter is often provided with a resistance in series with a low side switch of the half bridge inverter. This resistance can e.g. be used to measure the average HB input power in order to provide a measure or estimate for the lamp power. Obtaining a signal representative of the lamp power can be useful for dimming purposes. In order for the signal to be representative of the lamp power, the signal should not be contaminated by other power components.

In known heating circuits however, the heating current may also be arranged to flow through the resistance. As a result, employing the resistance to determine or estimate the lamp power may be compromised when known heating circuits are applied. The same applies when further known lamp load circuits are connected in parallel. It has further been proposed in EP 1 191 824 to provide a heating circuit in series with a series-resonant lamp load circuit, wherein the heating circuit comprises a switch connected in parallel to a primary winding of a heating transformer. In such a circuit, however, a comparatively large and thus expensive switch controlling a heating current of the transformer may need to be provided.

### SUMMARY OF THE INVENTION

It is desirable to provide an electronic ballast for a lamp load, in particular an inductive lamp load, that mitigates at least one of the aforementioned drawbacks.

Therefore, in an aspect of the invention, there is provided an electronic ballast for supplying a lamp load, the electronic ballast comprising:

an inverter comprising an upper switch, connected to a DC terminal for receiving a DC supply voltage, and a first lower switch arranged in a half-bridge configuration for generating an AC voltage at an inverter terminal of the inverter;

a series arrangement comprising a first diode and a second lower switch, wherein the series arrangement is connected in parallel with the first lower switch; and

a lamp load circuit for supplying the lamp load, wherein the lamp load circuit is connected to a node between the first diode and the second lower switch.

The electronic ballast according to the invention comprises an half-bridge inverter which, in use, can provide an AC voltage for powering a fluorescent lamp. The inverter can e.g. be connected to a DC voltage and convert the DC voltage into an AC voltage by appropriate switching of the upper and lower switches. The AC voltage, available at a terminal of the inverter, is provided to a lamp load circuit which may form a series-resonant circuit connectable to the fluorescent lamp. The lamp load circuit may in particular be an inductive lamp load circuit.

In an embodiment, the lamp load circuit can e.g. comprise a series connection of an inductance L and a capacitor C wherein the fluorescent lamp is connectable in parallel to the capacitor C. The lamp load circuit can further comprise a DC blocking capacitor either connected in series with the inductance L or in series with the fluorescent lamp and thus in parallel with the capacitor C.

In an embodiment, a second diode is connected between said node and the DC terminal The second diode functions as a freewheel diode.

In a simple embodiment, the series arrangement is connected to the inverter terminal.

In an alternative embodiment, the electronic ballast further comprises a follower circuit having a first power terminal, a second power terminal, and a control terminal, wherein the control terminal is connected to the inverter terminal, the first power terminal is connected to the DC terminal, and the second power terminal is connected to the first diode. In a ballast having a number of parallel inverters having a common upper switch, the follower circuit, which functions as a 1× linear amplifier, prevents current flowing in a lower switch of a first inverter to flow in a lower switch of another inverter. The follower circuit may e.g. be a source follower circuit comprising a MOSFET, or an emitter follower circuit comprising a bipolar transistor.

In an alternative embodiment, when the follower circuit comprises a MOSFET, the control terminal is connected to a control terminal of the upper switch, the first power terminal is connected to the DC terminal, and the second power terminal is connected to the first diode.

In an embodiment, a lamp load circuit of the electronic ballast may be a heating circuit. The heating circuit as applied in the electronic ballast according to the invention comprises a heating transformer for providing power to one or more electrodes of a fluorescent lamp. The heating transformer comprises a primary winding connected (e.g. via a capacitor) to the AC voltage of the inverter and a second lower (heating circuit) switch connected in parallel with the primary winding. By operating the second lower switch, the current through the primary winding of the heating transformer can be controlled.

The inverter of the electronic ballast according to the invention comprises two switches arranged in an half-bridge configuration. In such a configuration, two switches, e.g. metal oxide semiconductor field effect transistors, MOSFETs, e.g. NMOS type MOSFETs, are series connected between the supply voltage (e.g. a DC voltage or rectified AC voltage) of the inverter. The switch connected to the high voltage side of the supply voltage is referred to as the upper switch, the second switch, also referred to as the lower switch and connected in series with the upper switch, can e.g. be connected to ground, either directly or via an impedance such as a resistor. By alternating operation of the upper and lower switches, an AC voltage can be generated at an inverter terminal arranged between the two switches.

In an embodiment, the lamp load circuit further comprises a lamp load capacitor connected in series with the lamp load, the lamp load capacitor and the lamp load being connected in parallel to the second lower switch. In case of the lamp load being a heating circuit, a heating circuit capacitor is connected in series with the primary winding, the heating circuit capacitor and primary winding being connected in parallel to the lower (heating circuit) switch.

In the electronic ballast according to the invention, due to the parallel connection of the lamp load and the lower switch, one inverter of a number of parallel inverters sharing the same upper switch can be turned off entirely by maintaining the lower switch of the one inverter in an open state such that no AC voltage is provided to the lamp load of the one inverter. Such an arrangement can result in an improvement of the efficiency of the operation of the ballast. When taking known heating circuit arrangements, as e.g. disclosed in US 2007/0296355 or U.S. Pat. No. 5,854,538, as an example, the heating is turned off by opening a switch connected in series with the primary winding. However, due to the presence of a parasitic capacitance of an electronic switch such as a FET or MOSFET and the application of an AC voltage on the primary winding of the heating transformer, a leakage current may flow through the primary side of the heating transformer causing also a heating current through the electrode. The dissipation associated with this (leakage) current (dissipation occurring both in the transformer and in the electrode) is considered a power loss as it does not contribute to the lamp discharge current and thus results in a lower energy efficiency of a lighting application comprising the fluorescent lamp.

In an embodiment of the invention, the lower inverter switch and the lamp load of the electronic ballast are connected in parallel, possibly with other inverters and lamp load circuits.

In a heating circuit application, compared to electronic ballasts having a heating circuit arranged in series with the lamp load circuit, such as e.g. disclosed in EP 1 191 824, the power requirements for the heating circuit switch can be reduced, and may thus result in a smaller and cheaper switch.

In an embodiment, the electronic ballast according to the invention comprises a control unit for controlling the switching of the lower and upper switch of the inverter, and possibly further lower switches.

The above and other aspects of the invention will be more readily appreciated as the same becomes better understood by reference to the following detailed description and considered in connection with the accompanying drawings in which like reference symbols designate like parts.

### BRIEF DESCRIPTION OF THE DRAWINGS

FIG. 1 schematically depicts a circuit diagram of an electronic ballast for a fluorescent lamp as known in the art.

FIG. 2 schematically depicts a circuit diagram of a first embodiment of an electronic ballast according to the invention.

FIG. 3 schematically depicts graphs of simulation results of the first embodiment of the electronic ballast according to the invention.

FIG. 4 schematically depicts a circuit diagram of a second embodiment of the electronic ballast according to the invention.

FIG. 5 schematically depicts a circuit diagram of a third embodiment of the electronic ballast according to the invention.

FIG. 6 schematically depicts a circuit diagram of a fourth embodiment of the electronic ballast according to the invention.

FIG. 7 schematically depicts a circuit diagram of a fifth embodiment of an electronic ballast according to the invention.

FIG. 8 schematically depicts a circuit diagram of a sixth embodiment of an electronic ballast according to the invention.

### DETAILED DESCRIPTION OF EMBODIMENTS

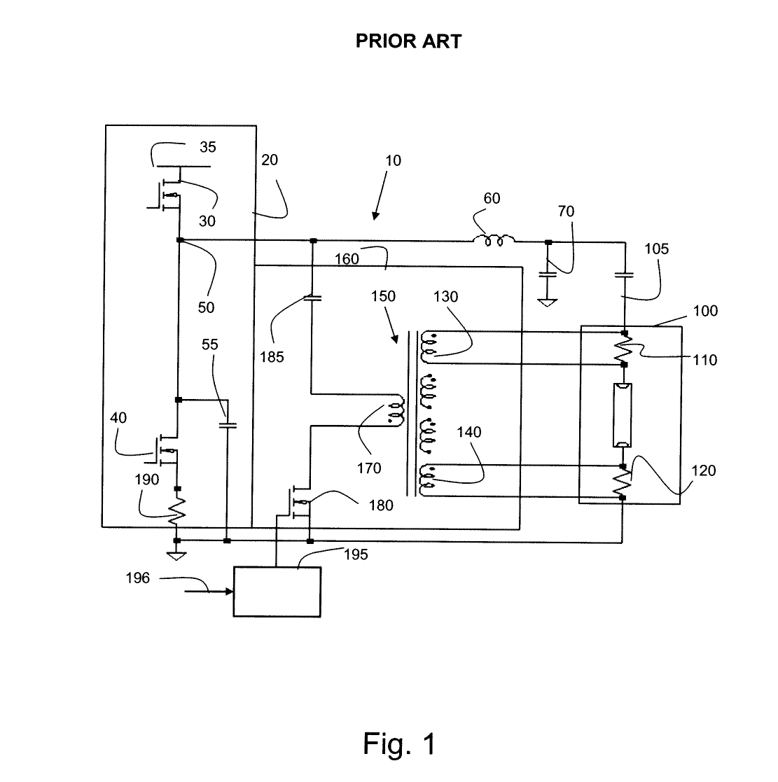

FIG. 1 schematically depicts an electronic ballast 10 for a fluorescent lamp as known in the art. The electronic ballast 10 comprises an inverter 20 (indicated by a rectangle) in half-bridge configuration comprising a series connection of an upper switch 30 (e.g., a metal oxide semiconductor field effect transistor, MOSFET) connected to a DC terminal 35, for receiving a DC supply voltage, and a lower switch 40 (e.g., a MOSFET) connected to the upper switch 30 via a terminal 50. In the embodiment of FIG. 1, the function of the inverter 20 is to provide an AC voltage (via the terminal 50) to a lamp load circuit comprising an inductance 60 and a capacitance 70 forming a series-resonant circuit connected to a fluorescent lamp 100 (indicated by a rectangle) via (decoupling) capacitance 105. The fluorescent lamp 100 comprises two electrodes 110 and 120 (represented by resistances). A heating circuit 160 is connected to terminal 50 in parallel with the lamp load circuit. The electrodes 110, 120 are each connected in parallel to secondary windings 130, 140, respectively, of a heating transformer 150 of the heating circuit 160 (indicated by a rectangle). The heating transformer 150 of the heating circuit 160 further comprises a primary winding 170. The heating circuit 160 further comprises a switch 180 (e.g. a MOSFET) and a (decoupling) capacitance 185 connected in series with the primary winding 170 of the heating transformer 150.

The switch 180 can be turned on and off by a microcontroller or other device or control unit 195 upon input of a control signal 196 in order to turn on or off the pre-heating of the electrodes 110, 120 before starting the lamp 100. The switch 180 can also be used to provide heating during operation of the lamp 100 at certain dimming levels. The switch 180 can be fed by the control unit 195 with a pulse-width modulated signal to control the amount of electrode heating. The control unit may also control switching of the upper switch 30 and lower switch 40.

As will be acknowledged by the skilled person, as all types of electronic switches have a parasitic capacitor, the series connection of the switch 180 and the primary winding 170 will, in use, cause a leakage current to flow through the primary winding 170 of the heating transformer 150 and thus also causing a heating current through the secondary windings 130, 140 and the electrodes 110, 120, even if the switch 180 is in an off (non-conducting) state.

FIG. 1 further shows a shunt resistor 190 or other impedance connected in series with the lower switch 40. The shunt resistor 190 can e.g. be used to measure an average inverter input power, thereby providing an estimate for the lamp power. This is particularly useful for dimming purposes. In the arrangement as shown, it will be apparent to the skilled person that the heating power as provided to the heating circuit 160 and electrodes 110, 120, the power loss in the inductance 60, and the power loss in the switch 40, are also measured by the shunt resistor 190 when the lower switch 40 is closed. When the fluorescent lamp is dimmed (thus requiring a comparatively small power), heating is likely to be applied in order to maintain the electrodes at a sufficiently high temperature. Due to the heating power being measured by the shunt resistor 190 as well, it can be noted that, in particular at low dimming levels, the heating circuit as shown in FIG. 1 is not very suitable when using the shunt resistor 190 for estimating or measuring the power provided to the fluorescent lamp 100.

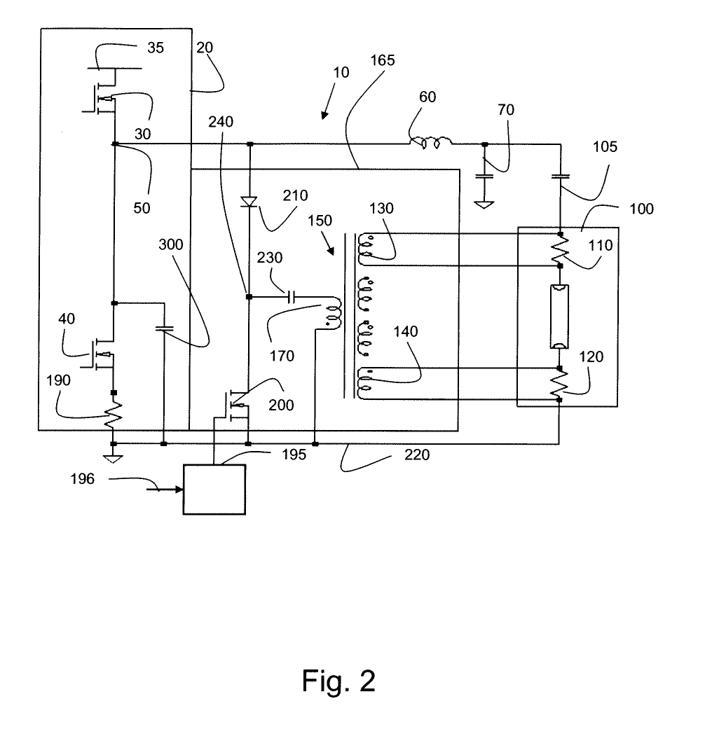

FIG. 2 schematically depicts a first embodiment of an electronic ballast for a fluorescent lamp according to the invention. The electronic ballast 10 comprises an inverter 20 in half-bridge configuration comprising an upper switch 30 connected to a DC terminal 35, for receiving a DC voltage, and a lower switch 40 connected to the upper switch 30 via a terminal 50. A lamp load circuit connected to the terminal 50 comprises an inductance 60 and a capacitance 70 forming a series-resonant circuit connected to a fluorescent lamp 100 through a (decoupling) capacitance 105. The ballast of FIG. 2 further comprises a heating circuit 165 (indicated by a rectangle) comprising a heating transformer 150 which comprises secondary windings 130, 140 which are connected in parallel to two electrodes 110 and 120 of the fluorescent lamp 100, and a primary winding 170. The heating circuit 165 further comprises a heating circuit switch 200 connected in parallel to the primary winding 170 of the heating transformer 150 through a (decoupling) capacitance 230. A terminal 240 connecting the capacitance 230 and the heating circuit switch 200 is connected to the terminal 50 through a diode 210.

The heating circuit switch 200 of the heating circuit can e.g. be turned on or off by a micro controller or other device or control unit 195 upon input of a control signal 196 in order to turn on or off the heating of the electrodes 110, 120, e.g. as a pre-heating before starting the fluorescent lamp 100. The switch 200 can also be used to provide heating during operation of the lamp 100 at predetermined dimming levels. The switch 200 can be fed by the control unit 195 with a pulse-width modulated signal to control the amount of electrode heating. The control unit may also control switching of the upper switch 30 and lower switch 40.

In case no heating of the electrodes of the fluorescent lamp is required, the heating circuit switch 200 can be kept continuously in an off state (non-conducting, open). In the off state, the arrangement of the diode 210 and capacitor 230 in series with the primary winding 170 ensure that, when the capacitor 230 is charged, no current will flow through the primary winding 170. Compared to the arrangement shown in FIG. 1, the effect of a parasitic capacitor in the heating circuit switch on the heating power can thus be eliminated thereby improving the efficiency of the electronic ballast compared to arrangements as e.g. shown in FIG. 1 or described in US 2007/0296355 or U.S. Pat. No. 5,854,538.

When the heating circuit switch 200 is closed (with the upper switch 30 being in an off state), a current path is provided that enables the heating current on the primary side of the heating transformer 150 to flow to ground 220. By providing the heating circuit switch 200 in parallel to the primary winding 170 of the heating transformer 150, a current path is provided that enables, upon closing of the heating circuit switch 200 the heating current on the primary side of the heating transformer 150 to flow to ground 220 through the heating circuit switch 200 rather than through the lower switch 40 as in the prior art. As a result, the heating current does not flow through impedance or shunt resistor 190, which, as explained above with reference to FIG. 1, can be applied to obtain an estimate for the power provided to the fluorescent lamp 10. As such, the signal derived from e.g. a voltage measurement over the shunt resistor 190 can provide a better estimate for the lamp power, compared to the heating circuit arrangement as shown in FIG. 1. As such, the electronic ballast 10 according to the invention enables the lamp power to be determined/estimated/approximated indirectly by determining the inverter input power, e.g. via a shunt resistance 190 in series with a lower switch 40 of the inverter.

In the electronic ballast according to the invention, as can be seen from FIG. 2, the heating circuit switch and primary winding are arranged in parallel with the lamp load circuit, rather than in series with the lamp load circuit as e.g. disclosed in EP 1 191 824. By doing so, the heating circuit switch 200 need not be dimensioned to the current flowing through the lamp load circuit (formed by the series-resonant circuit of inductance 60 and capacitance 70). Therefore, compared to the heating circuit switch as applied in EP 1 191 824, the heating circuit switch 200 of the heating circuit 165 as applied in the electronic ballast according to the invention can be selected smaller and/or cheaper. The heating circuit arrangement as applied in the electronic ballast according to the invention thus enables the application of low-cost components.

In an embodiment, the heating circuit switch 200 is operated in synchronism with the lower switch 40 of the inverter through the control unit 195 controlling the operation of the heating circuit switch 200. Note that, in an embodiment, the control unit 195 for providing a signal to the heating circuit switch 200 to turn the switch on or off may also be arranged to control the operation of the upper switch 30 and lower switch 40 of the inverter 20 of the electronic ballast according to the invention. In such an arrangement, the control of the heating circuit switch 200 is simplified as it is synchronized with the operation of the lower switch 40 of the inverter. In general, the upper and lower switch of the inverter are operated in an alternating manner, each thus approximately at a duty cycle of 50%. The duty cycle of the heating circuit switch 200 can thus be selected equal to the duty cycle of the lower switch 40. The heating circuit switch 200 may however also be operated at a smaller duty cycle (still in synchronism with the lower switch 40), thereby controlling the heating power provided to the electrodes of the fluorescent lamp.

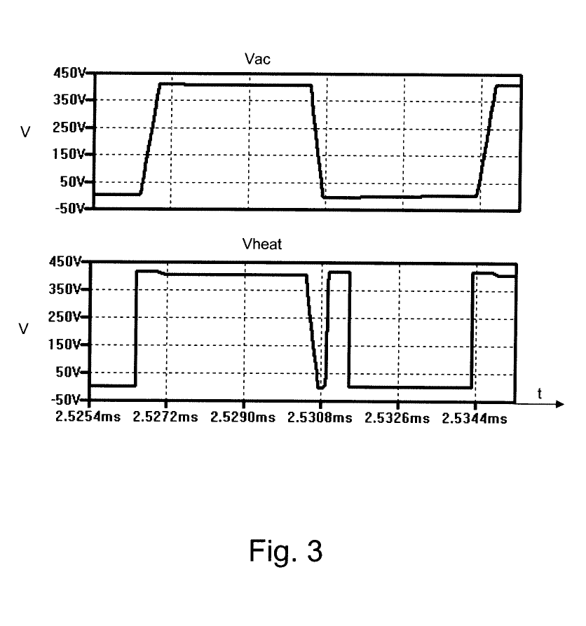

In order to reduce EMI generated by the electronic ballast and to lower switching losses, a capacitor 300 is often added at the terminal 50. By adding such a capacitor 300, it has been observed that the heating circuit as proposed, e.g. the embodiment as shown in FIG. 2, may still, to a minor extent, affect the inverter input power measurement. This is illustrated in the following graphs (FIG. 3) obtained from simulations.

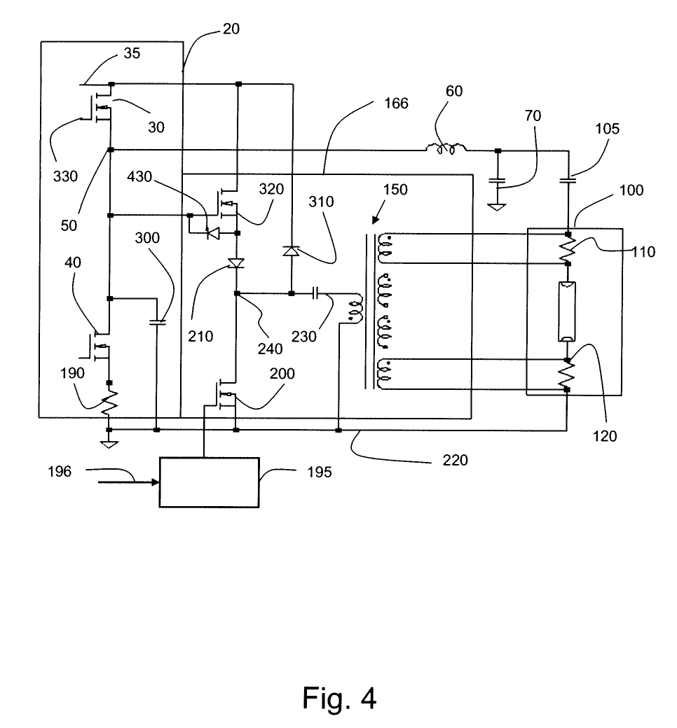

The upper graph of FIG. 3 schematically depicts the AC voltage Vac (as a function of time t) available at the terminal 50 (see FIG. 2) of the inverter 20 during operation (whereby the upper and lower switch of the inverter are switched on and off in an alternating manner, e.g. each operating at a duty cycle of 50%). The lower graph of FIG. 3 schematically depicts the voltage Vheat (as a function of time t) available at node 240 (see FIG. 2) when the heating circuit switch 200 is operated in synchronism with the lower switch 40 of the inverter. As can be observed, the slope of the rising edge of the Vac signal is lower than the slope of the falling edge. This difference in the slopes is due to the fact that when a capacitor 300 (e.g. added at the terminal 50) is charged, it is only charged with the current through inductance 60 and during the falling edge this capacitor 300 is discharged with the sum of the current through inductance 60 and the current of the heating transformer flowing through, which flows through diode 210. In order to avoid a current flowing between the heating transformer primary winding 170 and the capacitor 300, an embodiment of the electronic ballast according to the invention is amended as shown in FIG. 4.

FIG. 4 schematically depicts a second embodiment of the electronic ballast according to the invention. Compared to the embodiment as shown in FIG. 2, the following additions and changes are made to the electronic ballast and its heating circuit 166. A freewheeling diode 310 is provided connecting the heating circuit switch 200 with the DC terminal 35. The embodiment further comprises a device 320 operating as 1× linear amplifier. As an example, the device 320 comprises a MOSFET with a diode 430 connected between the source and the gate of the MOSFET, the anode of the diode 430 being connected to the source of the MOSFET (in which case the device 320 is known as a source follower). The (gate of the) device 320 can either be connected to the AC voltage of the inverter 20, available at terminal 50, or to a control terminal (gate) 330 of the upper switch of the inverter 20. FIG. 4 schematically depicts an embodiment of the electronic ballast according to the invention wherein the device 320 is a MOSFET connected to the AC voltage of the inverter 20, available at terminal 50.

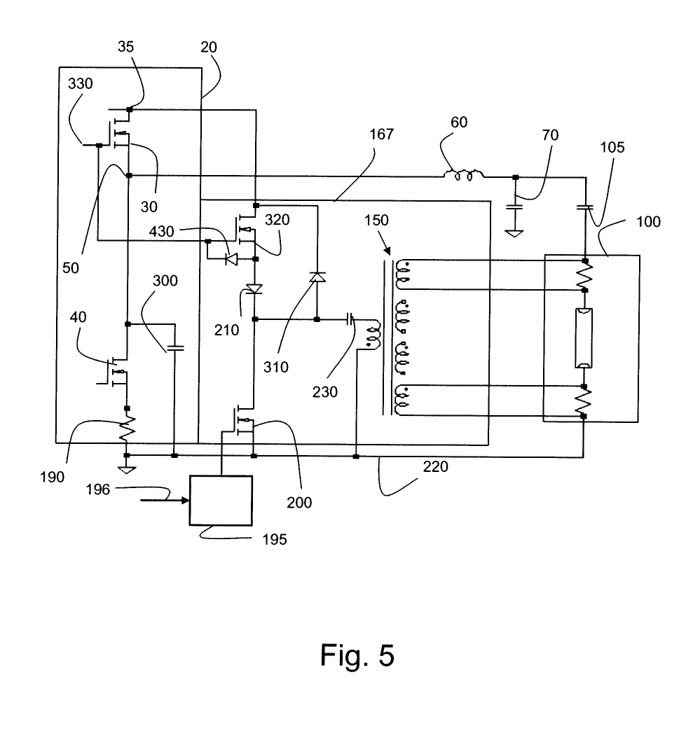

FIG. 5 schematically depicts an embodiment of the electronic ballast according to the invention wherein the device 320 of the heating circuit 167 is a MOSFET having a control terminal (gate) connected to the control terminal (gate) 330 of the upper switch 30 of the inverter 20.

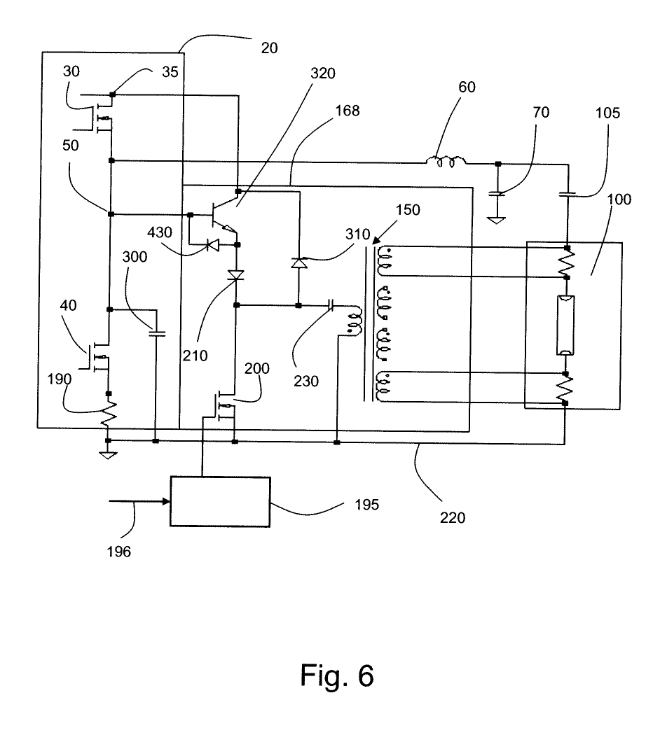

FIG. 6 schematically depicts an embodiment of the electronic ballast according to the invention wherein the device 320 of the heating circuit 168 comprises a bipolar transistor with a diode 430 connected between the emitter and the base of the bipolar transistor, the anode of the diode 430 being connected to the emitter of the bipolar transistor (in which case the device is known as an emitter follower). The (base of the) device 320 is connected to the AC voltage of the inverter, available at terminal 50.

It is further noted that, apart from device 320 and freewheeling diode 310, the embodiments of the electronic ballast according to the invention as shown in FIGS. 4-6 may comprise the same or similar components and may have the same or similar topology as the embodiment shown in FIG. 2.

According to FIGS. 4, 5 and 6, the device 320 establishes a connection between the DC terminal 35 and the diode 210 when the upper switch 30 is closed, drawing current for charging the capacitance 230 of the heating circuit 166, 167, 168, respectively, from the DC terminal 35, instead of from the terminal 50 and the capacitor 300. When the upper switch 30 is open, current may flow from the terminal 240 through the (freewheel) diode 310 to the DC terminal 35. The current does not flow through the shunt resistor 190, as desired.

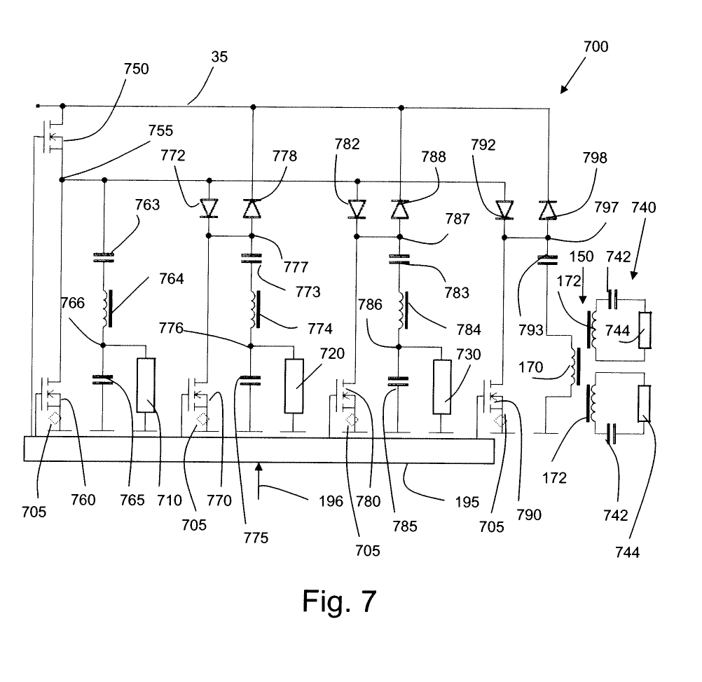

FIG. 7 schematically depicts a ballast 700 which is adapted to supply multiple lamp loads arranged in parallel. In the embodiment as shown in FIG. 7, one or more of four loads 710, 720, 730, 740 may be supplied by the ballast 700. Each of the loads 710, 720, 730 may be a fluorescent lamp or any other load. The load 740 comprises a transformer 150 having a primary winding 170 and secondary windings 172 each having a series connection of a capacitance 742 and a resistance 744 connected in parallel thereto. The resistances 744 may represent electrodes of a fluorescent lamp to be heated.

In the ballast 700, an upper switch 750, e.g. a MOSFET switch of an NMOS type, is connected to a DC terminal 35. A first inverter is formed by a series connection of the upper switch 750 and first lower switch 760 connected to the upper switch 750 via a terminal 755. A second inverter is formed by the upper switch 750 connected in series to a second lower switch 770 via the terminal 755 and a diode 772. A third inverter is formed by the upper switch 750 connected in series to a third lower switch 780 via the terminal 755 and a diode 782. A fourth inverter is formed by the upper switch 750 connected in series to a fourth lower switch 790 via the terminal 755 and a diode 792. The switches 750, 760, 770, 780 and 790 are switched on and off by a microcontroller or other device or control unit 195 upon input of one or more control signals 196 in order to supply one or more of the loads 710, 720, 730 and 740.

A first lamp load circuit connected to the terminal 755 comprises a series connection of a capacitance 763, and an inductance 764 and a capacitance 765 forming a series-resonant circuit. At a terminal 766 interconnecting the inductance 764 and the capacitance 765, the series-resonant circuit is connected to the load 710.

A second lamp load circuit connected to the terminal 755 through the diode 772 comprises a series connection of a capacitance 773, and an inductance 774 and a capacitance 775 forming a series-resonant circuit. At a terminal 776 interconnecting the inductance 774 and the capacitance 775, the series-resonant circuit is connected to the load 720. At a terminal 777, the series-resonant circuit is connected to the DC terminal 35 through a (freewheel) diode 778.

A third lamp load circuit connected to the terminal 755 through the diode 782 comprises a series connection of a capacitance 783, and an inductance 784 and a capacitance 785 forming a series-resonant circuit. At a terminal 786 interconnecting the inductance 784 and the capacitance 785, the series-resonant circuit is connected to the load 730. At a terminal 787, the series-resonant circuit is connected to the DC terminal 35 through a (freewheel) diode 788.

A fourth lamp load circuit connected to the terminal 755 through the diode 792 comprises a series connection of a capacitance 793 and the primary winding 170 of the transformer 150. At a terminal 797 interconnecting the diode 792 and the capacitance 793, the series connection is connected to the DC terminal 35 through a (freewheel) diode 798.

From FIG. 7, it appears that for each lamp load circuit, the corresponding switch 760, 770, 780, 790, respectively, is connected in parallel to the load circuit. The switch 750 is common for all lamp load circuits.

Switch 750 and switch 760 may be opened and closed in alternation, e.g. each with a duty cycle of 50% or less. Switch 750 and switch 770 are opened and closed in alternation, e.g. each with a duty cycle of 50% or less. Switch 770 may be operated independent from switch 760, or in combination therewith. Switch 750 and switch 780 are opened and closed in alternation, e.g. each with a duty cycle of 50% or less. Switch 780 may be operated independent from switches 760 and 770, or in combination with at least one of these. Switch 750 and switch 790 may be opened and closed in alternation, e.g. each with a duty cycle of 50% or less. Switch 790 may be operated independent from switches 760, 770 and 780, or in combination with at least one of them. The duty cycle of switch 790 may be made substantially lower than 50%, e.g. for a controlled pre-heating of electrodes of a fluorescent lamp. Alternatively, or additionally, a low-frequency pulse-width modulation may be applied to the high frequency switching control signal of the switch 790 supplied from the microcontroller or other device or control unit 195.

A high-side forward current is conducted by switch 750 for all lamp load circuits. A high-side reverse current of the first lamp load circuit is conducted by a body diode of switch 750. A high-side reverse current of the second lamp load circuit is conducted by diode 778. A high-side reverse current of the third lamp load circuit is conducted by diode 788. A high-side reverse current of the fourth lamp load circuit is conducted by diode 798.

The low-side forward and reverse current for the first lamp load circuit is conducted by switch 760 and its body diode. The low-side forward and reverse current for the second lamp load circuit is conducted by switch 770 and its body diode. The low-side forward and reverse current for the third lamp load circuit is conducted by switch 780 and its body diode. The low-side forward and reverse current for the fourth lamp load circuit is conducted by switch 790 and its body diode.

The current loading of each of the switches 760, 770, 780 and 790 is relatively low. The alternating currents through each of the switches 760, 770, 780 and 790 have a DC component that (for a predetermined DC terminal voltage) is a direct measure for the power extracted by the corresponding lamp load circuit. Thus, a current measurement for a particular load circuit can be made by averaging the current measured, e.g. by a shunt resistor 190 as shown in FIGS. 2, 4, 5 and 6 in series with the corresponding switch, e.g. at the source side of a MOSFET switch. In FIG. 7, shunt resistors are indicated by dashed diamonds 705.

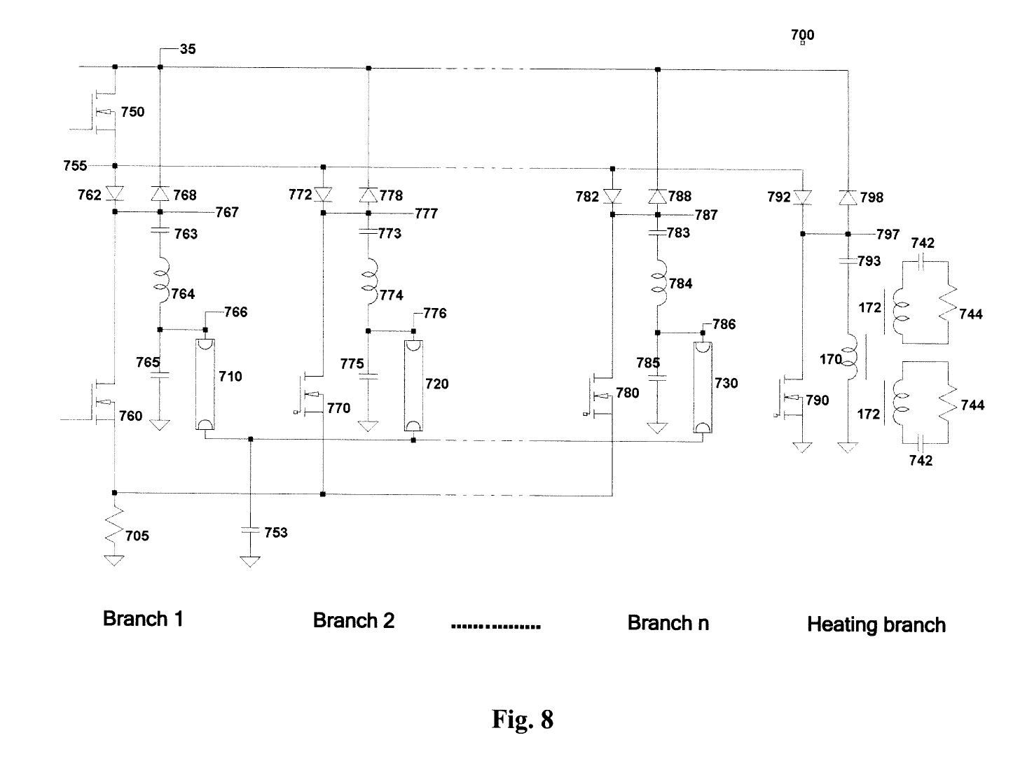

FIG. 8 schematically depicts another ballast 700′ which is adapted to supply multiple lamp loads arranged in parallel. Circuit parts in FIG. 8 that correspond to similar circuit parts in FIG. 7 are labeled with the same reference signs. With respect to the embodiment shown in FIG. 7, the following differences exist. Diode 762 has been added in series between lower switch 760 and terminal 755. The first lamp load circuit is connected to a terminal 767 between diode 762 and lower switch 760 instead of to terminal 755. Diode 768 (a freewheel diode) has been added and is connected between terminal 767 and DC terminal 35. The first, second and third lamp load circuit comprise capacitor 753. Ohmic resistor 705 is arranged in series with lower switch 705.

During operation of the circuit shown in FIG. 8, a high side reverse current of the first lamp load circuit is conducted by diode 768. Otherwise the operation of the circuitry shown in FIG. 8 is similar to that in FIG. 7.

In addition to the advantages offered by the circuitry shown in FIG. 7, in the circuitry shown in FIG. 8, each of the lower switches can be operated independent of the other lower switches. With this feature each lamp load circuit can be independently enabled or disabled, which cannot be fully accomplished in the circuitry shown in FIG. 7.

Various embodiments of an electronic ballast for supplying a lamp load have been described. In part of these embodiments the electronic ballast comprises an inverter arranged in a half-bridge configuration for providing an AC voltage and at least one lamp load circuit. The inverter comprises an upper switch, connected to a DC terminal for receiving a DC supply voltage, and a first lower switch arranged in a half-bridge configuration for generating an AC voltage at an inverter terminal of the inverter. A first diode and a second lower switch are connected in series. This series arrangement is connected in parallel with the first lower switch. A lamp load circuit for supplying the lamp load is connected to a node between the first diode and the second lower switch. When the inverter supplies a fluorescent lamp, and the lamp load circuit may comprise a heating circuit for heating an electrode of the fluorescent lamp, the heating circuit includes a heating transformer and a second lower switch connected in parallel with the primary winding of the transformer. By doing so, the heating circuit can be operated and controlled independently of the current supplied to the fluorescent lamp, or operating conditions of the fluorescent lamp. In other embodiments of an electronic ballast for supplying a lamp load the electronic ballast comprises an inverter arranged in a modified half-bridge configuration for providing an AC voltage and a number of lamp load circuits. The inverter comprises an upper switch, connected to a DC terminal for receiving a DC supply voltage, and a first diode in series with a first lower switch arranged in a modified half-bridge configuration for generating an AC voltage at an inverter terminal of the inverter. The ballast may further comprise a second diode and a second lower switch connected in series. This series arrangement is connected in parallel with the first diode and first lower switch. Possibly further series arrangements comprising a further diode and a further lower switch are connected in parallel with the first diode and the first lower switch. A lamp load circuit for supplying a first lamp load is connected to a node between the first diode and the first lower switch. A lamp load circuit for supplying a second lamp load is connected to a node between the second diode and the second lower switch. A further lamp load may be connected to a node between the further diode and the further lower switch. When the inverter supplies a fluorescent lamp, and the lamp load circuit comprises a heating circuit for heating an electrode of the fluorescent lamp, the heating circuit includes a heating transformer and a third lower switch connected in parallel with the primary winding of the transformer. By doing so, the heating circuit can be operated and controlled independently of the current supplied to the fluorescent lamp, or operating conditions of the fluorescent lamp.

It is noted that the term ‘lamp load’ as used in the description and claims may refer to fluorescent lamps, or a lamp electrode heating arrangement, but also may refer to solid state lighting devices, e.g. light emitting diode, LED, lighting devices.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

The term connected, as used herein, can be either directly or indirectly.

A single processor or other unit may fulfill the functions of the control unit as recited in the claims.

1. An electronic ballast for supplying a lamp load, the electronic ballast comprising:
an inverter comprising an upper switch, connected to a DC terminal for receiving a DC supply voltage, and a first lower switch arranged in a half-bridge configuration for generating an AC voltage at an inverter terminal of the inverter;
a series arrangement comprising a first diode and a second lower switch, wherein the series arrangement is connected in parallel with the first lower switch; and
a lamp load circuit for supplying the lamp load, wherein the lamp load circuit is connected to a node between the first diode and the second lower switch.

2. The electronic ballast according to claim 1, further comprising a second diode connected between said node and the DC terminal

3. The electronic ballast according to claim 1, wherein the series arrangement is connected to the inverter terminal.

4. The electronic ballast according to claim 1, further comprising a follower circuit having a first power terminal, a second power terminal, and a control terminal, wherein the control terminal is connected to the inverter terminal, the first power terminal is connected to the DC terminal, and the second power terminal is connected to the first diode.

5. The electronic ballast according to claim 1, further comprising a follower circuit having a first power terminal, a second power terminal, and a control terminal, wherein the control terminal is connected to a control terminal of the upper switch, the first power terminal is connected to the DC terminal, and the second power terminal is connected to the first diode.

6. The electronic ballast according to claim 4 or 5, wherein the follower circuit is a source follower circuit comprising a MOSFET.

7. The electronic ballast according to claim 4, wherein the follower circuit is an emitter follower circuit comprising a bipolar transistor.

8. The electronic ballast according to claim 1, wherein the lamp load circuit is a heating circuit for heating an electrode of a fluorescent lamp, the heating circuit comprising a heating transformer having a primary winding and a secondary winding for providing a current to the electrode of the fluorescent lamp.

9. The electronic ballast according to any preceding claim, wherein at least one of the first lower switch and the second lower switch is connected in series with an impedance.

10. The electronic ballast according to claim 9, wherein the impedance is a resistor.

11. The electronic ballast according to any preceding claim, wherein the inverter further comprises an inverter capacitor connected to the inverter terminal for reducing EMI.

12. The electronic ballast according to any preceding claim, further comprising a control unit for controlling the switching of the lower and upper switches.

13. An electronic ballast for supplying multiple lamp loads, the electronic ballast comprising:
a first DC terminal and a second DC terminal for coupling to the poles of a supply voltage source,
an upper switch, connected to the first DC terminal for receiving a DC supply voltage, and a plurality of series arrangements, each series arrangement comprising a lower switch and a lower diode and being arranged in series with said upper switch and connected to the second DC terminal, each of the series arrangements forming an inverter together with said upper switch and each of said lamp loads being connected to a different load terminal between a lower switch and a diode comprised in the same series arrangement and to the second DC terminal, and each load terminal being connected to the first DC terminal by means of a (freewheel) diode.

14. An electronic ballast as claimed in claim 1 or 13, wherein the lamp load circuit comprises a series arrangement of a resonant inductor and a resonant capacitor.
